(19) United States
(12) Patent Application Publication
(10) Pub. No.: US 2016/0053830 A1
(43) Pub. Date: Feb. 25, 2016

(54) Electromagnetic Clutch And Method For Producing Electromagnetic Clutch

(71) Applicant: SANDEN HOLDINGS CORPORATION, Gunma (JP)

(72) Inventor: Masanori MOGI, Isesaki-shi (JP)

(73) Assignee: Sanden Holdings Corporation, Isesaki- shi (JP)

(21) Appl. No.: 14/780,961

(22) PCT Filed: Mar. 17, 2014
(86) PCT No.: PCT/JP2014/057091

§ 371 Date: Sep. 28, 2015

(30) Foreign Application Priority Data
Mar. 29, 2013 (JP) 2013-074754
Dec. 24, 2013 (JP) 2013-265586

(51) Int. Cl. F16D 27/108; F16D 27/14

(52) U.S. Cl. CPC F16D 27/108; F16D 27/14; F16D 2027/001

(57) ABSTRACT

An electromagnetic clutch 1 including a thermal fuse 4, includes base portions 57a and 57b that are provided on a flange portion 522 of a bobbin 52 apart from each other and respectively include: wire locking portions 57a1 and 57b1 for locking a drawn wire part 511 of an electromagnetic coil 51 drawn onto the flange portion 522 halfway through a process of winding the electromagnetic coil around the bobbin; and thermal fuse locking portions 57a3 and 57b3 for locking lead wires 4b and 4c of the thermal fuse 4 apart from the drawn wire part 511. Each locking portion is provided along the circumferential direction of the flange portion 522. The lead wires 4b and 4c are connected between one end 511a of the drawn wire part 511 in one base portion 57a and one end 511b of the drawn wire part 511 in the other base portion 57b.

### TECHNICAL FIELD

The present invention relates to an electromagnetic clutch and to a method for producing an electromagnetic clutch. The present invention particularly relates to an electromagnetic clutch including a thermal fuse for forcibly interrupting energization of an electromagnetic coil, and relates to a method for producing the electromagnetic clutch.

### BACKGROUND ART

As this type of electromagnetic clutch, an electromagnetic clutch disclosed in Patent Document 1 is known as an example. The electromagnetic clutch disclosed in Patent Document 1 includes: a bobbin around which an electromagnetic coil is wound; and a thermal fuse for interrupting energization of the electromagnetic coil when a temperature thereof exceeds a predetermined temperature. In the electromagnetic clutch, the thermal fuse is connected by crimping the winding termination end of the electromagnetic coil wound around the bobbin to the end of one lead wire of the thermal fuse using a crimping terminal and crimping the end of the other lead wire of the thermal fuse to a conductor for connecting to an external power source using a crimping terminal.

### REFERENCE DOCUMENT LIST

### Patent Document

Patent Document 1: Japanese Patent Application Laid-open Publication No. H8-247171

### SUMMARY OF THE INVENTION

### Problems to be Solved by the Invention

In the electromagnetic clutch disclosed in Patent Document 1, after the electromagnetic coil is wound around the bobbin, the unfixed winding termination end of the electromagnetic coil needs to be connected to one lead wire of the thermal fuse via a crimping terminal. A winding collapse of the electromagnetic coil may occur during this crimping operation. In addition, a conductor other than the electromagnetic coil wound around the bobbin needs to be prepared to connect the other lead wire of the thermal fuse and the external power source, which requires techniques.

The present invention has been made in view of such circumstances, and the present invention has an object to provide an electromagnetic clutch with which a winding collapse of an electromagnetic coil when connecting a thermal fuse is suppressed and the operation of connecting the thermal fuse is simplified, and to provide a method for producing the electromagnetic clutch.

### Means for Solving the Problems

An electromagnetic clutch according to one aspect of the present invention is an electromagnetic clutch including: an electromagnetic coil unit including a bobbin around which an electromagnetic coil is wound, and for causing, when the electromagnetic coil is energized, a rotor rotated by a driving source and an armature connected to a rotary shaft of a driven device to magnetically adhere to each other to thereby enable transmission of power of the driving source to the driven device; and a thermal fuse for forcibly interrupting the energization of the electromagnetic coil when a temperature thereof exceeds a predetermined temperature, in which the electromagnetic coil unit includes a pair of base portions provided on a flange portion of the bobbin apart from each other in a circumferential direction, each of the base portions including: a wire locking portion for locking a drawn wire part of the electromagnetic coil drawn from an outer edge of the flange portion onto the flange portion halfway through a process of winding the electromagnetic coil around the bobbin; and a thermal fuse locking portion for locking a lead wire of the thermal fuse apart from the drawn wire part. The wire locking portion and the thermal fuse locking portion are each provided along the circumferential direction of the flange portion, and the lead wire of the thermal fuse locked to the thermal fuse locking portion is electrically connected between one end of the drawn wire part in one of the base portions and one end of the drawn wire part in the other one of the base portions.

According to another aspect of the present invention, the wire locking portion includes a groove portion in which the drawn wire part of the electromagnetic coil is fitted, and a side wall on a bobbin inner peripheral side defining the groove portion is higher than a side wall on a bobbin outer peripheral side defining the groove portion.

A method for producing an electromagnetic clutch according to one aspect of the present invention is a method for producing an electromagnetic clutch that includes: an electromagnetic coil unit including a bobbin around which an electromagnetic coil is wound, and for causing, when the electromagnetic coil is energized, a rotor rotated by a driving source and an armature connected to a rotary shaft of a driven device to magnetically adhere to each other to thereby enable transmission of power of the driving source to the driven device; and a thermal fuse for forcibly interrupting the energization to the electromagnetic coil when a temperature thereof exceeds a predetermined temperature, the method including: a step of winding the electromagnetic coil around the bobbin; a step of holding a drawn wire part of the electromagnetic coil drawn from an outer edge of a flange portion of the bobbin onto the flange portion halfway through a process of winding the electromagnetic coil around the bobbin, by fitting the drawn wire part into a wire locking portion formed in each of a pair of base portions provided on the flange portion apart from each other in a circumferential direction while pressing the drawn wire part against a side wall on a bobbin inner peripheral side that is higher than a side wall on a bobbin outer peripheral side from among side walls defining the groove portion; and a step of electrically connecting the thermal fuse between one end of the drawn wire part in one of the base portions and one end of the drawn wire part in the other one of the base portions.

According to another aspect of the present invention, the wire locking portion includes a groove portion into which the drawn wire part of the electromagnetic coil is fitted, and in the step of holding, the drawn wire part of the electromagnetic coil by fitting the drawn wire part into the groove portion, while pressing the drawn wire part against a side wall on a bobbin inner peripheral side that is higher than a side wall on a bobbin outer peripheral side from among side walls defining the groove portion.

### Effects of the Invention

The electromagnetic clutch according to the present invention has a connection structure in which the thermal fuse is connected to the electromagnetic coil in the following manner: in a state in which the drawn wire part of the electromagnetic coil drawn from the outer edge of the flange portion onto the flange portion halfway through the process of winding the electromagnetic coil around the bobbin is locked to the wire locking portion formed in each of the pair of base portions provided on the flange portion of the bobbin apart from each other in the circumferential direction, each lead wire of the thermal fuse locked to the thermal fuse locking portion is electrically connected between one end of the drawn wire part in one base portion and one end of the drawn wire part in the other base portion. Accordingly, not only one lead wire but also the other lead wire of the thermal fuse can be connected using the electromagnetic coil that is halfway through being wound around the bobbin, and thus, it is not required to prepare a conductor for connecting to the external power source other than the electromagnetic coil wound around the bobbin, the operation of connecting the thermal fuse can be simplified as compared with the conventional techniques. In addition, the operation of connecting the thermal fuse to the electromagnetic coil can be performed in a state in which the electromagnetic coil is held by the pair of base portions, and thus, it is possible to prevent a winding collapse of the electromagnetic coil.

In the electromagnetic clutch according to another aspect of the present invention, the wire locking portion is provided along the circumferential direction of the flange portion and includes the groove portion in which the drawn wire part of the electromagnetic coil is fitted, and the side wall on the bobbin inner peripheral side defining the groove portion is higher than the side wall on the bobbin outer peripheral side defining the groove portion. This enables the drawn wire part to be fitted into the groove portion in a state in which the drawn wire part is pressed against the side wall on the bobbin inner peripheral side to apply tension. As a result, a winding collapse of the electromagnetic coil can be prevented more reliably. Moreover, the drawn wire part can be held by the base portions in the series of operations following the electromagnetic coil winding operation, without changing the position of the bobbin at the time of the winding operation. Thus, the efficiency of the connecting operation can be increased.

In the method for producing an electromagnetic clutch according to the present invention, it is possible to connect the thermal fuse to the electromagnetic coil in the following manner: In a state in which the drawn wire part of the electromagnetic coil which is drawn from the outer edge of the flange portion onto the flange portion halfway through the process of winding the electromagnetic coil around the bobbin, is held by being fitted in the wire locking portion formed in each of the pair of base portions provided on the flange portion of the bobbin apart from each other in the circumferential direction, the thermal fuse is electrically connected between one end of the drawn wire part in one base portion and one end of the drawn wire part in the other base portion. Since it is not required to prepare a conductor for connecting to the external power source other than the electromagnetic coil wound around the bobbin, the operation of connecting the thermal fuse can be simplified as compared with the conventional techniques. In addition, it is possible to prevent a winding collapse of the electromagnetic coil.

In the method for producing an electromagnetic clutch according to another aspect of the present invention, the step of holding the drawn wire part by fitting the drawn wire part into the wire locking portion is performed while pressing the drawn wire part against the side wall on the bobbin inner peripheral side that is higher than the side wall on the bobbin outer peripheral side. As a result, it is possible to prevent a winding collapse of the electromagnetic coil, more reliably. Moreover, it is possible to carry out the winding operation and the drawn wire part holding operation as a series of operations, which increases the efficiency of the connecting operation.

### BRIEF DESCRIPTION OF THE DRAWINGS

FIG. 1 is an exploded perspective view of an electromagnetic clutch according to an embodiment of the present invention.

FIG. 2 is a sectional view of the electromagnetic clutch.

FIG. 3 is an exploded perspective view of an electromagnetic coil unit.

FIG. 4 is a perspective view around a thermal fuse and base portions.

FIG. 5 is an enlarged perspective view of a base portion and its vicinity.

FIG. 6 is a perspective view of a connecting terminal.

FIG. 7 is a side view of the connecting terminal as viewed from the direction of arrow A illustrated in FIG. 6.

FIG. 8 is an assembly view of the electromagnetic coil unit.

FIG. 9 is a view for explaining a method of connecting a thermal fuse.

FIG. 10 is a view for explaining a modification example of the method of connecting a thermal fuse.

### MODE FOR CARRYING OUT THE INVENTION

Hereinafter, embodiments of an electromagnetic clutch according to the present invention will be described with reference to the accompanying drawings.

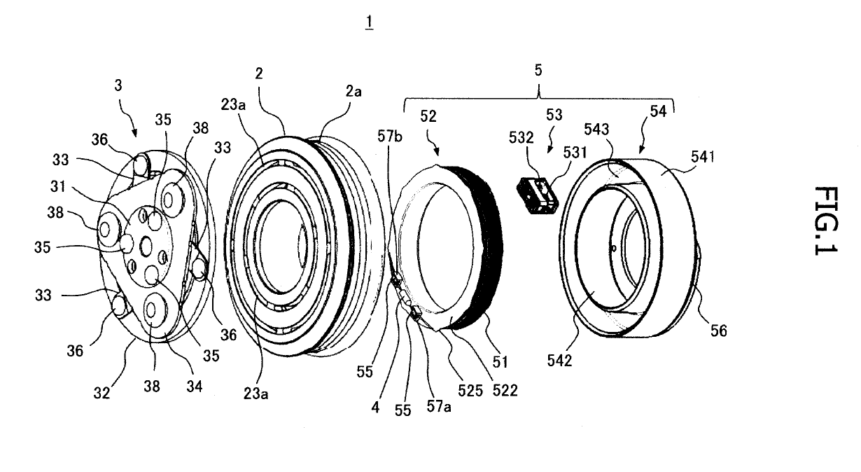

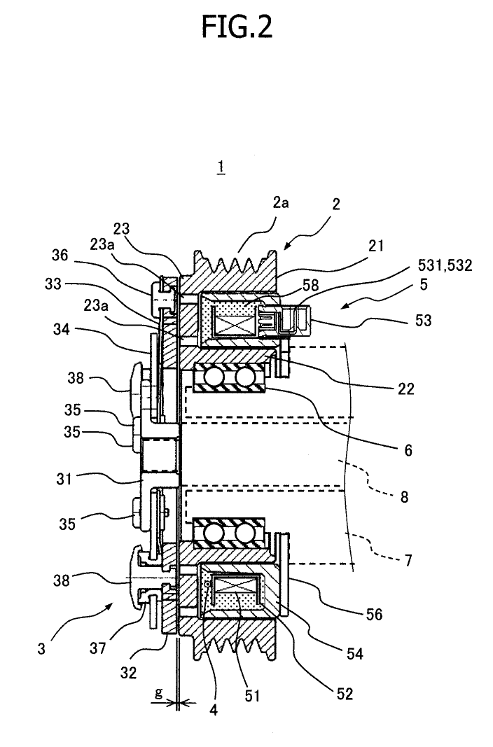

FIGS. 1 and 2 illustrate the structure of an electromagnetic clutch 1 according to an embodiment of the present invention. FIG. 1 is an exploded perspective view of the electromagnetic clutch 1, and FIG. 2 is a sectional view of the electromagnetic clutch 1.

For example, the electromagnetic clutch 1 according to this embodiment is incorporated in a compressor in an air conditioner of a vehicle, and intermittently transmits power of an engine or motor of the vehicle as a driving source to the compressor as a driven device. In detail, the electromagnetic clutch 1 switches between transmitting and interrupting power from the engine or the motor to the compressor. The compressor operates when power is transmitted from the engine or the motor, and stops operation when power from the engine or the motor is interrupted.

As illustrated in FIGS. 1 and 2, the electromagnetic clutch 1 includes: a rotor 2 rotated by power from the engine or the motor; an armature 3 facing the rotor 2; a thermal fuse 4; and an electromagnetic coil unit 5 for causing the rotor 2 and the armature 3 to magnetically adhere to each other.

The rotor 2 is ring-shaped, and its inner peripheral surface is rotatably supported by the outer peripheral surface of a housing 7 (indicated by dashed lines in FIG. 2) of the compressor via a bearing 6. Belt grooves 2a are formed in the outer peripheral surface of the rotor 2, and the outer peripheral surface of the rotor 2 functions as a pulley. In more detail, the rotor 2 includes: an outer cylindrical portion 21 which has the outer peripheral surface; an inner cylindrical portion 22 which has the inner peripheral surface and is concentric with the outer cylindrical portion 21; and an annular disk-shaped connecting portion 23 which connects the outer cylindrical portion 21 and the inner cylindrical portion 22 at one end. These are integrated to form the rotor 2 (see FIG. 2). The connecting portion 23 serving as one end surface of the rotor 2 has slits 23a intermittently extending in the circumferential direction, as a magnetic flux blocking portion.

A driving belt (not illustrated) is attached to the outer peripheral surface of the rotor 2 on which the belt grooves 2a are formed. The rotor 2 is rotated by the power of the engine or motor transmitted via the driving belt. The below-mentioned electromagnetic coil unit 5 is placed in the space defined by the outer cylindrical portion 21, the inner cylindrical portion 22, and the connecting portion 23.

The armature 3 includes: a cylindrical hub 31 having a flange portion; a disk-shaped armature plate 32 made of a magnetic material; a plurality of (three in this example) leaf springs 33; and a triangular damping plate 34.

The hub 31 is fixed (connected) to one end of a rotary shaft (driving shaft) 8 (indicated by dashed lines in FIG. 2) of the compressor protruding out of the housing 7 by a nut (not illustrated), in a spline-engaged state as an example.

The armature plate 32 faces the end surface (the connecting portion 23) of the rotor 2.

Each of the leaf springs 33 has one end fixed to the flange portion of the hub 31 by a rivet 35 together with the damping plate 34, and the other end fixed to the armature plate 32 by a rivet 36. Each of the leaf springs 33 biases the armature plate 32 away from the end surface (the connecting portion 23) of the rotor 2. This creates a predetermined gap g between the end surface (the connecting portion 23) of the rotor 2 and the armature plate 32.

The damping plate 34 has antivibration rubber 37 attached to near each vertex thereof. The damping plate 34 and the antivibration rubber 37 are fixed to the armature plate 32 by rivets 38, and damp vibration generated in the armature plate 32.

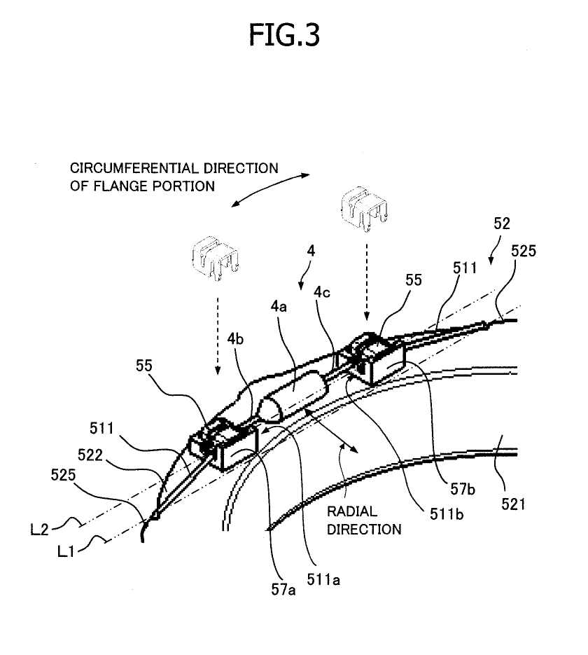

The thermal fuse 4 forcibly interrupts energization of the below-mentioned electromagnetic coil 51 when a temperature thereof exceeds a predetermined temperature. Lead wires 4b and 4c extend from both ends of a thermal fuse body 4a, as illustrated in FIG. 3. The lead wires 4b and 4c of the thermal fuse body 4a are locked to the below-mentioned thermal fuse locking portions (third groove portions 57a3 and 57b3). In the below-mentioned pair of base portions 57a and 57b, the lead wires 4b and 4c are electrically connected (hardwired) between one end 511a of a drawn wire part 511 in a base portion 57a and one end 511b of the drawn wire part 511 in the other base portion 57b. In this embodiment, the lead wires 4b and 4c of the thermal fuse 4 are connected to the electromagnetic coil 51 (the drawn wire part 511) via a pair of connecting terminals 55, 55 fitted in the pair of base portions 57a and 57b, The method of connecting the thermal fuse 4 will be described in detail later.

Referring back to FIGS. 1 and 2, the electromagnetic coil unit 5 causes, when the electromagnetic coil 51 is energized, the rotor 2 and the armature 3 to magnetically adhere to each other to enable the transmission of the power of the driving source to the driven device. The electromagnetic coil unit 5 includes: the electromagnetic coil 51 (illustrated in the state of being densely wound around a bobbin in FIG. 1); a bobbin 52 around which the electromagnetic coil 51 is wound; a power supply connector 53 attached to the bobbin 52; a field core 54; and the pair of connecting terminals 55, 55 for connecting the thermal fuse 4.

A mounting plate 56 is attached to one end surface of the field core 54. The electromagnetic coil unit 5 is accommodated in the above-mentioned space (that is, the space defined by the outer cylindrical portion 21, the inner cylindrical portion 22, and the connecting portion 23) of the rotor 2, in the state of being mounted on (fixed to) the housing 7 of the compressor via the mounting plate 56 (see FIG. 2).

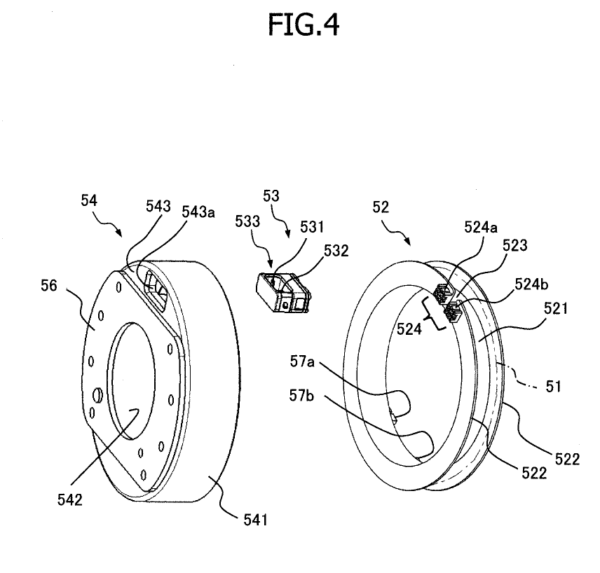

FIG. 4 is an exploded perspective view of the electromagnetic coil unit 5 as viewed from the opposite side to FIG. 1. In FIG. 4, the below-mentioned locking portions 525 of the bobbin 52 illustrated in FIG. 1 are not illustrated to simplify the representation.

As illustrated in FIG. 4, the bobbin 52 includes: a cylindrical portion 521 having the electromagnetic coil 51 wound around its outer peripheral surface; and flange portions 522 provided on both ends of the cylindrical portion 521.

A connector mounting portion 524 to which the power supply connector 53 is attached is provided on the outer surface of one of the flange portions 522, and a notch 523 is formed in part of the outer periphery of the flange portion 522. A plurality of (eight in FIG. 1) locking portions 525 (see FIG. 1) protruding outward are formed on the periphery (outer edges) of each flange portion 522, apart from each other in the circumferential direction of the flange portion 522. The connector mounting portion 524 will be described in detail later.

The pair of base portions 57a and 57b are provided on the outer surface of the other flange portion 522 apart from each other, as illustrated in FIGS. 1, 3, and 4. The pair of base portions 57a and 57b each include: a wire locking portion for locking the drawn wire part 511 of the electromagnetic coil 51 drawn from the outer edge of the flange portion 522 onto the flange portion 522 halfway through the process of winding the electromagnetic coil 51 around the bobbin 52; and a thermal fuse locking portion for locking the lead wire 4b or 4c of the thermal fuse 4 apart from the drawn wire part 511.

In this embodiment, the wire locking portion includes a first groove portion 57a1 or 57b1 in which the drawn wire part 511 is fitted, and the thermal fuse locking portion includes a third groove portion 57a3 or 57b3 in which the lead wire 4b or 4c of the thermal fuse 4 is fitted. Hereinafter, the wire locking portion is referred to as the first groove portion 57a1 or 57b1, and the thermal fuse locking portion as the third groove portion 57a3 or 57b3.

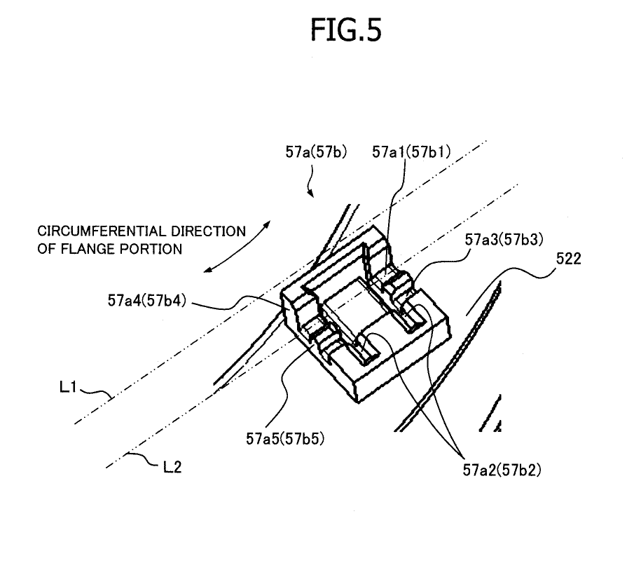

In detail, as illustrated in FIG. 5, one base portion 57a includes: the first groove portion 57a1 in which one end of the drawn wire part 511 (see FIG. 3) of the electromagnetic coil 51 drawn from the outer edge of the flange portion 522 onto the flange portion 522 (outer surface) of the bobbin 52 via the locking portion 525 (see FIGS. 1 and 3) halfway through the process of winding the electromagnetic coil 51 around the bobbin 52, is fitted; second groove portions 57a2 intersecting with the first groove portion 57a1; and the third groove portion 57a3 provided on the bobbin outer peripheral side relative to the first groove portion 57a1 and apart from the first groove portion 57a1, and extending in parallel with the first groove portion 57a1. Likewise, the other base portion 57b includes: the first groove portion 57b1 in which the other end of the drawn wire part 511 is fitted; second groove portions 57b2 intersecting with the first groove portion 57b1; and the third groove portion 57b3 provided on the bobbin outer peripheral side relative to the first groove portion 57b1 and apart from the first groove portion 57b1, and extending in parallel with the first groove portion 57b1.

In this embodiment, as illustrated in FIG. 3, at least a pair of locking portions 525 out of the locking portions 525 formed on the flange portion 522 is formed so as to sandwich the pair of base portions 57a and 57b, and furthermore, as illustrated in FIGS. 3 and 5, at least the pair of locking portions 525 is formed so that an imaginary line L1 passing through the pair of locking portions 525 is positioned radially inward (closer to the center of the flange portion 522) relative to an imaginary line L2 passing through the pair of first groove portions 57a1 and 57b1.

In this embodiment, the second groove portions 57a2 or 57b2 are formed in a pair extending in parallel with each other.

In this embodiment, each of the below-mentioned pair of connecting pieces 55a are fitted in the second groove portions 57a2 or 57b2. In addition, the lead wire 4b or 4c of the thermal fuse 4 fitted in the below-mentioned second sandwiching portion 552 formed in the pair of connecting pieces 55a, 55a, is fitted in the third groove portion 57a3 or 57b3. Thus, the lead wire 4b or 4c is securely held by the second sandwiching portion 552 and the third groove portion 57a3 or 57b3. Although a notch is formed between the pair of second groove portions 57a2 (57b2) in this embodiment as illustrated in FIG. 5, the embodiment of the present invention is not limited thereto, and the notch need not be provided between the pair of second groove portions 57a2 (57b2).

The pair of base portions 57a and 57b are made of resin as an example, and provided apart from each other in the circumferential direction of the flange portion 522 (see FIG. 3). Each of the first groove portions 57a1 and 57b1 is provided along the circumferential direction of the flange portion 522 (see FIG. 5). Of the side walls defining the first groove portion 57a1 or 57b1, a side wall 57a4 or 57b4 on the bobbin inner peripheral side is higher than a side wall 57a5 or 57b5 on the bobbin outer peripheral side defining the first groove portion 57a1 or 57b1. Both side walls defining the third groove portion 57a3 or 57b3 are lower than the side wall 57a4 or 57b4 on the bobbin inner peripheral side, as illustrated in FIG. 5.

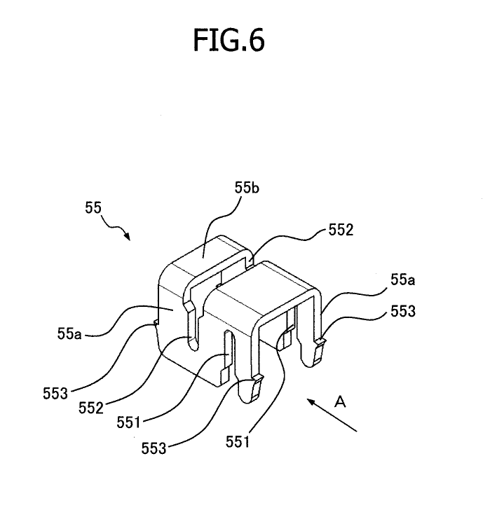

In this embodiment, each of the pair of connecting terminals 55 are fitted in the pair of base portions 57a and 57b. In detail, each connecting terminal 55 is made of an electroconductive material. For example, as illustrated in FIG. 6, each connecting terminal 55 is fitted in the second groove portions 57a2 or 57b2, and includes: a slit-shaped first sandwiching portion 551 for sandwiching the drawn wire part 511 fitted in the first groove portion 57a1 or 57b1; and a slit-shaped second sandwiching portion 552 which is opened in the opposite direction to the first sandwiching portion 551 and for sandwiching the lead wire 4b or 4c of the thermal fuse 4. The opening of the first sandwiching portion 551 is increased in width so that the drawn wire part 511 can be easily fitted in. Likewise, the opening of the second sandwiching portion 552 is increased in width so that the lead wire 4b or 4c of the thermal fuse 4 can be easily fitted in.

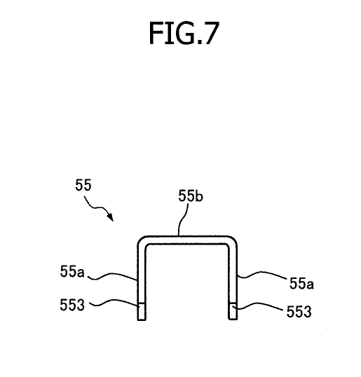

In more detail, in this embodiment, as illustrated in FIGS. 6 and 7, each connecting terminal 55 is U-shaped and includes: the pair of connecting pieces 55a, 55a facing each other; and a joining piece 55b for joining the pair of connecting pieces 55a, 55a at one end. Each connecting piece 55a has an opening at the other end to form the first sandwiching portion 551, and an opening at the one end (on the joining piece 55b side) to form the second sandwiching portion 552. A locking portion 553 is formed in the peripheral edge of each connecting piece 55a on the side of inserting into the second groove portion 57a2 (57b2) to ensure that the connecting piece 55a engages with the second groove portion 57a2 or 57b2. The joining piece 55b is opened to form a groove corresponding to the second sandwiching portion 552. This enables the lead wire 4b or 4c to be fitted into the second sandwiching portion 552 from above the joining piece 55b.

Referring back to FIG. 4, the connector mounting portion 524 has the notch 523 disposed therebetween. In detail, the connector mounting portion 524 is divided into two parts, that is, a first connector mounting portion 524a and a second connector mounting portion 524b. Each of the first connector mounting portion 524a and the second connector mounting portion 524b has a groove extending away from the notch 523 along the outer surface of the flange portion 522, as illustrated in FIG. 4. The winding start end of the electromagnetic coil 51 around the cylindrical portion 521 is fitted in one of the groove of the first connector mounting portion 524a and the groove of the second connector mounting portion 524b, and the winding termination end of the electromagnetic coil 51 is fitted in the other one of the groove of the first connector mounting portion 524a and the groove of the second connector mounting portion 524b. In other words, both ends (tail ends) of the electromagnetic coil 51 wound around the outer peripheral surface of the cylindrical portion 521 are drawn out of the flange portion 522 through the notch 523, and then bent opposite to each other and fitted in each groove.

The power supply connector 53 is attached to (pressed against) the connector mounting portion 524 of the bobbin 52, and supplies power to the electromagnetic coil 51 when connected to a power connector (not illustrated). As illustrated in FIG. 1, the power supply connector 53 includes: a first connector pin 531 electrically connected to one end of the electromagnetic coil 51 fitted in the groove of the first connector mounting portion 524a when the power supply connector 53 is attached to the connector mounting portion 524; and a second connector pin 532 electrically connected to the other end of the electromagnetic coil 51 fitted in the groove of the second connector mounting portion 524b when the power supply connector 53 is attached to the connector mounting portion 524. An opening 533 in which the power connector is attached is formed in one side surface of the power supply connector 53, and the power ends of the connector pins 531 and 532 are formed in the opening 533 so as to protrude.

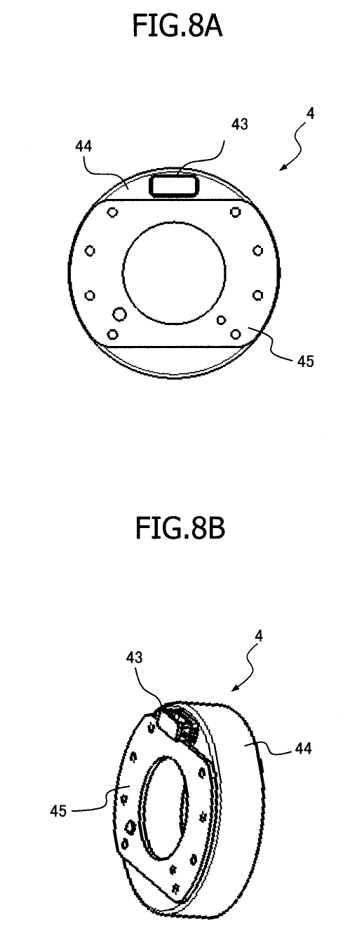

The field core 54 is ring-shaped similar to the rotor 2, as illustrated in FIGS. 1, 2, and 4. In detail, the field core 54 includes: an outer cylindrical portion 541; an inner cylindrical portion 542 concentric with the outer cylindrical portion 541; and an annular disk-shaped connecting portion 543 connecting the outer cylindrical portion 541 and the inner cylindrical portion 542 at one end. The connecting portion 543 has a through hole 543a. The field core 54 accommodates the bobbin 52 to which the power supply connector 53 is attached, in the space defined by the outer cylindrical portion 541, the inner cylindrical portion 542, and the connecting portion 543. In more detail, as illustrated in FIGS. 8A and 8B, the field core 54 accommodates the proximal part of the power supply connector 53 and the bobbin 52 in the above-mentioned space in a state in which the distal part of the power supply connector 53 is exposed to the outside from the through hole 543a. The space is then filled with resin 58. The resin with which the space is filled seals the electromagnetic coil 51, and the electromagnetic coil 51, the bobbin 52, the power supply connector 53, and the field core 54 are integrally formed. In this manner, the electromagnetic coil unit 5 is completed.

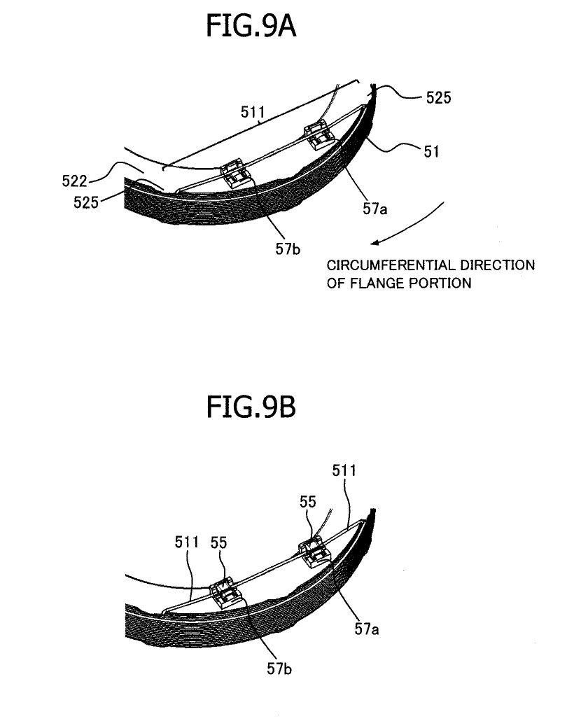

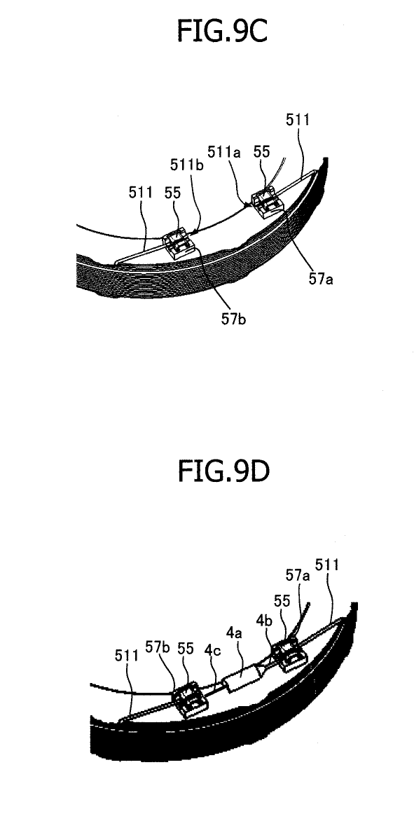

The method for producing the electromagnetic clutch 1 in this embodiment is described below with reference to FIGS. 4 and 9A to 9D, mainly focusing on the step of connecting the thermal fuse 4. Here, the details of the base portions 57a and 57b and connecting terminals 55, 55 are described with reference to FIGS. 5 and 6. The method for producing the electromagnetic clutch 1 described below is an embodiment of the method for producing an electromagnetic clutch according to the present invention.

The method for producing the electromagnetic clutch 1 includes: a step of winding the electromagnetic coil around the bobbin; a step of holding the drawn wire part; and a step of electrically connecting the thermal fuse. In this embodiment, the step of electrically connecting the thermal fuse includes: fitting each connecting terminal 55 into the pair of base portions 57a and 57b to press the drawn wire part 511; removing the drawn wire part 511 between the pair of base portions; and fixing the lead wires 4b and 4c of the thermal fuse 4 to each connecting terminal 55 fitted in the pair of base portions 57a and 57b, to electrically connect the thermal fuse 4 to the electromagnetic coil 51 via the connecting terminals 55.

The following describes each of the steps in detail.

First, for example, one end (one tail end) of the electromagnetic coil 51 is held by being fitted into the groove of the first connector mounting portion 524a (see FIG. 4) formed on one flange portion 522. In this state, the electromagnetic coil 51 is inserted through the notch 523 to the cylindrical portion 521 side, and wound around the outer peripheral surface of the bobbin 52, that is, the cylindrical portion 521. Halfway through the winding process, the other end of the electromagnetic coil 51 is hooked on the locking portion 525 of the other flange portion 522 and is drawn from the outer edge of the flange portion 522 onto the flange portion 522. This step and the below-mentioned remaining winding step correspond to the step of winding the electromagnetic coil around the bobbin in the method for producing an electromagnetic clutch according to the present invention.

Next, as illustrated in FIG. 9A, the drawn wire part 511 of the electromagnetic coil 51 which is drawn from the outer edge of the flange portion 522 onto the flange portion 522 halfway through the process of winding the electromagnetic coil 51 around the bobbin 52, is held by being fitted into the first groove portions 57a1 and 57b1 (see FIG. 5) formed in the pair of base portions 57a and 57b while pressing the drawn wire part 511. In detail, the drawn wire part 511 is held by being fitted into the first groove portions 57a1 and 57b1 while being pressed against the side walls 57a4 and 57b4 (see FIG. 5) on the bobbin inner peripheral side toward the bobbin inner periphery, in a state in which tension is applied. The drawn wire part 511 is thus held by the pair of base portions 57a and 57b. This step corresponds to the step of holding the drawn wire part in the method for producing an electromagnetic clutch according to the present invention.

The drawn electromagnetic coil 51 is drawn back to the cylindrical portion 521 side via another locking portion 525 located at a position at which the electromagnetic coil 51 has been drawn out, and, while being wound around the outer peripheral surface of the cylindrical portion 521, routed to the flange portion 522 side at which the connector mounting portion 524 is formed. The other end (the other tail end) of the electromagnetic coil 51 is then fitted into the groove of the second connector mounting portion 524b (see FIG. 4) via the notch 523. In this manner, the remaining winding step of the electromagnetic coil 51 is terminated. The remaining winding step is performed between the above-mentioned step of holding the drawn wire part and the below-mentioned step of pressing the drawn wire part in this embodiment; however, it is not limited to this, and the remaining winding step may be performed at any timing, such as after the step of pressing the drawn wire part, as long as it is after the step of holding the drawn wire part.

The connecting terminals 55 (the connecting pieces 55a) are then fitted into the second groove portions 57a2 and 57b2 (see FIG. 5), and the drawn wire part 511 is pressed by each first sandwiching portion 551 (see FIG. 6) to securely hold the drawn wire part 511, as illustrated in FIG. 9B. Thus, the drawn wire part 511 is securely held by the pair of base portions 57a and 57b. This step is hereafter referred to as the step of pressing the drawn wire part.

Next, the drawn wire part 511 between the pair of base portions 57a and 57b is removed, as illustrated in FIG. 9C. This step is hereafter referred to as the step of removing the drawn wire part. Although the drawn wire part 511 between the pair of base portions 57a and 57b is removed before the lead wires 4b, 4c of the thermal fuse 4 are fitted into the connecting terminals 55 (the second sandwiching portions 552) in this embodiment as described later, the timing of the removing is not limited to this. For example, in a case in which it is possible to fit the lead wires 4b and 4c into the second sandwiching portions 552 without causing the thermal fuse body 4a to touch the drawn wire part 511 in a state in which the drawn wire part 511 extends between the pair of base portions 57a and 57b, the above-mentioned step of removing the drawn wire part may be performed after the below-mentioned step of connecting via the connecting terminals.

Next, as illustrated in FIG. 9D, the end of one lead wire 4b of the thermal fuse 4 is fitted into the second sandwiching portion 552 of the connecting terminal 55 fitted in one base portion 57a and is also fitted into the third groove portion 57a3 of the base portion 57a, so that the lead wire 4b is fixed. The end of the other lead wire 4c of the thermal fuse 4 is fitted into the second sandwiching portion 552 of the connecting terminal 55 fitted in the other base portion 57b, and also fitted into the third groove portion 57b3 of the base portion 57b, so that the lead wire 4c is fixed. The thermal fuse 4 is thus inserted in an intermediate part of the electromagnetic coil 51 via the connecting terminals 55, to electrically connect the thermal fuse 4 to the electromagnetic coil 51. This step is hereafter referred to as the step of connecting via the connecting terminals.

In this way, the thermal fuse 4 is electrically connected between one end 511a of the drawn wire part 511 in one base portion 57a and one end 511b of the drawn wire part 511 in the other base portion 57b, through the step of pressing the drawn wire part, the step of removing the drawn wire part, and the step of connecting via the connecting terminals. A step including the step of pressing the drawn wire part, the step of removing the drawn wire part, and the step of connecting via the connecting terminals in this embodiment corresponds to the step of electrically connecting the thermal fuse in the method for producing an electromagnetic clutch according to the present invention.

The following describes the outline of the operation of the electromagnetic clutch 1 in this embodiment.

When the electromagnetic coil unit 5 is supplied with external power via the power supply connector 53, the electromagnetic coil 51 is energized to generate an electromagnetic force, to cause the armature plate 32 to magnetically adhere to the end surface (the connecting portion 23) of the rotor 2 against the biasing force of the leaf springs 33. The rotor 2 and the armature 3 are thus connected. The rotary force of the rotor 2 (that is, the power of the engine or motor) is transmitted to the armature 3, and further transmitted to the rotary shaft 8 of the compressor, as a result of which the compressor operates. Here, for example in a case in which frictional heat is generated due to, for example, a magnetic adhesion defect between the armature 3 and the rotor 2, the thermal fuse 4 attached to the flange portion 522 detects the heat, and forcibly interrupts energization of the electromagnetic coil 51. When the power supply to the electromagnetic coil unit 5 is forcibly interrupted, the armature plate 32 is apart from the end surface (the connecting portion 23) of the rotor 2 by the biasing force of the leaf springs 33. The transmission of the rotary force of the rotor 2 is thus interrupted, as a result of which the compressor stops.

With the electromagnetic clutch 1 and the method for producing the electromagnetic clutch 1 according to this embodiment, it is possible to provide an electromagnetic clutch and a method for producing an electromagnetic clutch having such a connection structure that can connect the thermal fuse 4 to the electromagnetic coil 51 in the following manner. In a state in which the drawn wire part 511 of the electromagnetic coil 51 which is drawn from the outer edge (the locking portion 525) of the flange portion 522 onto the flange portion 522 halfway through the process of winding the electromagnetic coil 51 around the bobbin 52, is locked to the wire locking portion (the first groove portion) 57a1 or 57b1 formed in each of the pair of base portions 57a and 57b provided on the flange portion 522 of the bobbin 52 apart from each other in the circumferential direction, the lead wires 4b and 4c of the thermal fuse 4 are electrically connected between one end 511a of the drawn wire part 511 in one base portion 57a and one end 511b of the drawn wire part 511 in the other base portion 57b. Thus, not only one lead wire 4b but also the other lead wire 4c of the thermal fuse 4 can be connected using the electromagnetic coil 51 that is halfway through being wound around the bobbin 52. Since it is not required to prepare a conductor for connecting to the external power source other than the electromagnetic coil 51 wound around the bobbin 52, the operation of connecting the thermal fuse can be simplified as compared with the conventional techniques. In addition, the operation of connecting the thermal fuse 4 to the electromagnetic coil 51 can be performed in a state in which the electromagnetic coil 51 is held by the pair of base portions 57a and 57b, with it being possible to prevent a winding collapse of the electromagnetic coil 51.

The wire locking portion 57a1 or 57b1 is provided along the circumferential direction of the flange portion 522 and includes the groove portion (the first groove portion) in which the drawn wire part 511 of the electromagnetic coil 51 is fitted, and the side wall 57a4 or 57b4 on the bobbin inner peripheral side defining the first groove portion 57a1 or 57b1 is higher than the side wall 57a5 or 57b5 on the bobbin outer peripheral side defining the first groove portion 57a1 or 57b1. This enables the drawn wire part 511 to be fitted into the first groove portion 57a1 or 57b1 in a state in which the drawn wire part 511 is pressed against the side wall 57a4 or 57b4 on the bobbin inner peripheral side to apply tension. As a result, a winding collapse of the electromagnetic coil 51 can be prevented more reliably. Moreover, the drawn wire parts 511 can be held by the base portions 57a and 57b in the series of operations following the operation of winding the electromagnetic coil 51, without changing the position of the bobbin 52 at the time of the winding operation. Thus, the efficiency of the connection operation can be increased.

In this embodiment, at least a pair of locking portions 525 out of the locking portions 525 formed on the flange portion 522 are positioned so as to sandwich the pair of base portions 57a and 57b, and the imaginary line L1 passing through the pair of locking portions 525 is positioned radially inward relative to the imaginary line L2 passing through the pair of first groove portions 57a1 and 57b1. Thus, the drawn wire part 511 is easily pressed against the side walls 57a4 and 57b4 in the series of winding operations. Note that the positional relationship between the locking portions 525 and the first groove portions 57a1 and 57b1 is not limited to this. Another example of the positional relationship is that at least a pair of locking portions 525 are positioned so as to sandwich the pair of base portions 57a and 57b, and the imaginary line L1 passing through the pair of locking portions 525 is positioned radially outward relative to the imaginary line L2 passing through the pair of first groove portions 57a1 and 57b1, which is not illustrated. In this case, by forming the side wall 57a5 or 57b5 on the bobbin outer side higher than the side wall 57a4 and 57b4 on the bobbin inner side, the drawn wire part 511 can be pressed against the side wall 57a5 or 57b5 on the bobbin outer side to apply tension.

Although the embodiment describes the case in which the thermal fuse 4 is fitted into the connecting terminals 55 after the connecting terminals 55 are fitted into the pair of base portions 57a and 57b, the procedure of fitting the connecting terminals 55 and the thermal fuse 4 is not limited to this. For example, although not shown, in a case in which it is possible to fit the lead wires 4b and 4c into the second sandwiching portions 552 without causing the thermal fuse body 4a to touch the drawn wire part 511 as mentioned above, the connecting terminals 55, 55 in a state in which the lead wires 4b and 4c are fitted in the second sandwiching portions 552 (that is, the assembly of the thermal fuse 4 and the pair of connecting terminals 55, 55) may be fitted into the pair of base portions 57a and 57b (the second groove portions 57a2 and 57b2).

Although the embodiment describes the case in which the second sandwiching portion 552 is opened in the opposite direction to the first sandwiching portion 551, the direction of the opening is not limited to this. For example, in a case in which it is possible to fit the lead wires 4b and 4c into the third groove portions 57a3 and 57b3 without causing the thermal fuse body 4a to touch the drawn wire part 511 as mentioned above, the second sandwiching portion 552 may be opened in the same direction as the first sandwiching portion 551. In this case, the second sandwiching portion 552 sandwiches the lead wire 4b or 4c fitted in the third groove portion 57a3 or 57b3, from above.

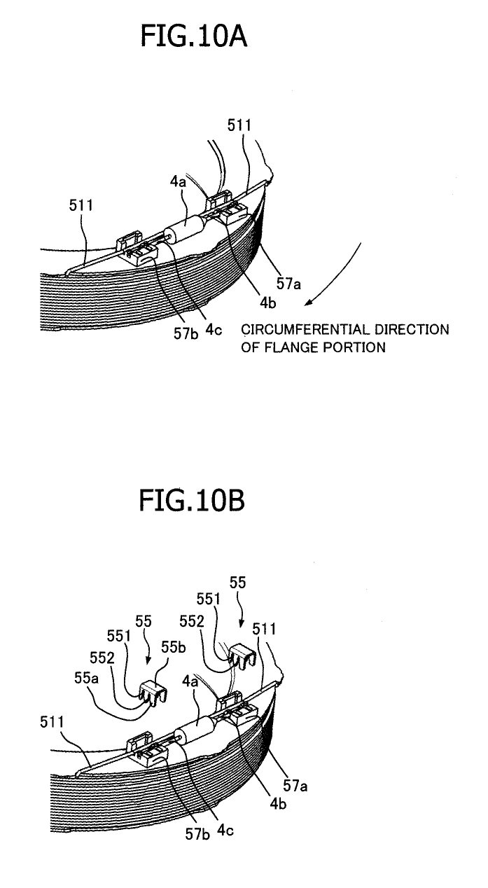

In more detail, as illustrated in FIG. 10B, each connecting terminal 55 is U-shaped and includes: the pair of connecting pieces 55a, 55a facing each other; and the joining piece 55b connecting the pair of connecting pieces 55a, 55a at one end, and each connecting piece 55a has openings at the other end to form the first sandwiching portion 551 and the second sandwiching portion 552.

The method for producing the electromagnetic clutch 1 in the above-mentioned case in which the first sandwiching portion 551 and the second sandwiching portion 552 are both opened to the pair of base portions 57a and 57b is described below, with reference to FIGS. 9, 10A, and 10B.

The method for producing the electromagnetic clutch 1 in a modification example differs from that illustrated in FIG. 9 only in the step of electrically connecting the thermal fuse, and is the same as that illustrated in FIG. 9 in the other steps (the step of winding the electromagnetic coil around the bobbin and the step of holding the drawn wire part by fitting) and thus, the explanation is omitted.

In this modification, the step of electrically connecting the thermal fuse includes: fixing the lead wires 4b and 4c of the thermal fuse 4 to the pair of base portions 57a and 57b; fitting each connecting terminal 55 into the pair of base portions 57a and 57b and pressing the drawn wire part 511 and the lead wires 4b and 4c, to electrically connect the thermal fuse 4 to the electromagnetic coil 51 via the connecting terminals 55; and removing the drawn wire part 511 between the pair of base portions. The following describes each of the steps in detail.

First, halfway through the process of winding the electromagnetic coil 51 around the bobbin 52, as illustrated in FIG. 9A, the electromagnetic coil 51 is drawn from the outer edge of the flange portion 522 onto the flange portion 522, and the drawn wire part 511 is held by being fitted into the first groove portions 57a1 and 57b1. Next, the lead wires 4a and 4b of the thermal fuse 4 are fixed by being fitted respectively into the pair of base portions 57a and 57b (the third groove portions 57a3 and 57b3), as illustrated in FIG. 10A. As illustrated in FIG. 10B, each connecting terminal 55 is then fitted into the pair of base portions 57a and 57b (the second groove portions 57a2 and 57b2) and the drawn wire part 511 and the lead wires 4b and 4c are pressed, thus securely holding the drawn wire part 511 and the lead wires 4b and 4c. In this way, the thermal fuse 4 is electrically connected to the electromagnetic coil 51 via the connecting terminals 55. Following this, not illustrated, the drawn wire part 511 between the pair of base portions 57a and 57b is removed. In this manner, the connection of the electromagnetic clutch according to the modification is completed.

The embodiment and the modification illustrated in FIG. 10A describes the case in which each connecting terminal 55 is U-shaped and includes: the pair of connecting pieces 55a, 55a facing each other; and the joining piece 55b for joining the pair of connecting pieces 55a, 55a; however, it is not limited to this. The connecting terminal 55 may be made up of one connecting piece or three or more connecting pieces, as long as the sandwiching portions 551 and 552 are each open in the appropriate direction. In this case, the second groove portions 57a2 and 57b2 in each of the base portions 57a and 57b are formed according to the number of connecting pieces in the connecting terminal 55. The connecting terminal 55 may have any structure as long as it is fitted in the corresponding one of the pair of base portions 57a and 57b, includes the slit-shaped first sandwiching portion 551 for sandwiching the drawn wire part 511 and the slit-shaped second sandwiching portion 552 for sandwiching the lead wire 4b or 4c of the thermal fuse 4, and electrically connects the thermal fuse 4 and the drawn wire part 511.

The embodiment and the modification describe the case in which the pair of connecting terminals 55 are provided apart from the pair of base portions 57a and 57b; however, it is not limited to this. For example, although not shown, the pair of connecting pieces 55a, 55a may be insert-molded in the pair of base portions 57a and 57b beforehand. In this case, the first sandwiching portion 551 and the second sandwiching portion 552 are both opened upward (the opposite direction to the base portions 57). For example, in a case in which the drawn wire part 511 and the fuse body 4a are kept from touching each other, the drawn wire part 511 is fixed by being fitted into the first sandwiching portion 551 and the lead wire 4b or 4c is fixed by being fitted into the second sandwiching portion 552 to electrically connect the electromagnetic coil 51 and the thermal fuse 4, and the drawn wire part 511 between the pair of base portions 57a and 57b is removed.

The method for producing an electromagnetic clutch according to the present invention is not limited to those described in the embodiment and the modification, as long as it is a method for producing an electromagnetic clutch that includes: an electromagnetic coil unit including a bobbin around which an electromagnetic coil is wound, and for causing, when the electromagnetic coil is energized, a rotor rotated by a driving source and an armature connected to a rotary shaft of a driven device to magnetically adhere to each other to enable transmission of power of the driving source to the driven device; and a thermal fuse for forcibly interrupting the energization to the electromagnetic coil when a temperature thereof exceeds a predetermined temperature, the method including: a step of winding the electromagnetic coil around the bobbin; a step of holding a drawn wire part of the electromagnetic coil which is drawn from an outer edge of a flange portion of the bobbin onto the flange portion halfway through a process of winding the electromagnetic coil around the bobbin, by fitting the drawn wire part into a wire locking portion formed in each of a pair of base portions provided on the flange portion apart from each other in a circumferential direction while pressing the drawn wire part against a side wall on a bobbin inner peripheral side that is higher than a side wall on a bobbin outer peripheral side from among side walls defining the groove portion; and a step of electrically connecting the thermal fuse between one end of the drawn wire part in one of the base portions and one end of the drawn wire part in the other one of the base portions.

Although preferred embodiments of the present invention have been described above, the present invention is not limited to the foregoing embodiments, and various modifications and changes are possible based on the technical idea of the present invention.

### REFERENCE SYMBOL LIST

1 Electromagnetic clutch
4 Thermal fuse
4b, 4c Lead wire
5 Electromagnetic coil unit
51 Electromagnetic coil
52 Bobbin
55 Connecting terminal
55a, 55a Pair of connecting pieces
55b Connecting piece
57a, 57b Pair of base portions
57a1, 57b1 Groove portion (first groove portion)
57a3, 57b3 Another groove portion (third groove portion)
57a4, 57b4 Side wall on bobbin inner peripheral side
57a5, 57b5 Side wall on bobbin outer peripheral side
511 Drawn wire part
511a One end of drawn wire part in one base portion
511b One end of drawn wire part in other base portion
522 Flange portion
551 First sandwiching portion
552 Second sandwiching portion

1. An electromagnetic clutch comprising:
an electromagnetic coil unit including a bobbin around which an electromagnetic coil is wound, and for causing, when the electromagnetic coil is energized, a rotor rotated by a driving source and an armature connected to a rotary shaft of a driven device to magnetically adhere to each other to enable transmission of power of the driving source to the driven device; and
a thermal fuse which forcibly interrupts the energization to the electromagnetic coil when a temperature thereof exceeds a predetermined temperature,
wherein the electromagnetic coil unit includes: a pair of base portions provided on a flange portion of the bobbin apart from each other in a circumferential direction, each of the base portions including: a wire locking portion for locking a drawn wire part of the electromagnetic coil drawn from an outer edge of the flange portion onto the flange portion halfway through a process of winding the electromagnetic coil around the bobbin; and a thermal fuse locking portion for locking a lead wire of the thermal fuse apart from the drawn wire part,
wherein the wire locking portion and the thermal fuse locking portion are each provided along the circumferential direction of the flange portion, and
wherein the lead wire of the thermal fuse locked to the thermal fuse locking portion is electrically connected between one end of the drawn wire part in one of the base portions and one end of the drawn wire part in the other one of the base portions.

2. The electromagnetic clutch according to claim 1, wherein the wire locking portion includes a groove portion in which the drawn wire part of the electromagnetic coil is fitted, and
wherein a side wall on a bobbin inner peripheral side defining the groove portion is higher than a side wall on a bobbin outer peripheral side defining the groove portion.

3. The electromagnetic clutch according to claim 1, wherein the electromagnetic coil unit further includes a pair of connecting terminals that are fitted in the pair of base portions, each connecting terminal includes a slit-shaped first sandwiching portion for sandwiching the drawn wire part and a slit-shaped second sandwiching portion for sandwiching the lead wire of the thermal fuse, and electrically connects the thermal fuse and the drawn wire part.

4. The electromagnetic clutch according to claim 3, wherein in each of the pair of connecting terminals, an opening direction of the first sandwiching portion is opposite to an opening direction of the second sandwiching portion.

5. The electromagnetic clutch according to claim 4, wherein each of the connecting terminals is U-shaped and includes: a pair of connecting pieces facing each other; and a joining piece for joining the pair of connecting pieces at one end, each of the connecting pieces having an opening at the other end to form the first sandwiching portion, and an opening at the one end to form the second sandwiching portion.

6. The electromagnetic clutch according to claim 3,
wherein the thermal fuse locking portion includes a groove in which the lead wire of the thermal fuse is fitted, and
wherein in each of the pair of connecting terminals, an opening direction of the first sandwiching portion is the same as an opening direction of the second sandwiching portion.

7. The electromagnetic clutch according to claim 6, wherein each of the connecting terminals is U-shaped and includes: a pair of connecting pieces facing each other; and a joining piece for joining the pair of connecting pieces at one end, each of the connecting pieces having openings at the other end to form the first sandwiching portion and the second sandwiching portion.

8. A method for producing an electromagnetic clutch that includes: an electromagnetic coil unit including a bobbin around which an electromagnetic coil is wound, and for causing, when the electromagnetic coil is energized, a rotor rotated by a driving source and an armature connected to a rotary shaft of a driven device to magnetically adhere to each other to enable transmission of power of the driving source to the driven device; and a thermal fuse which forcibly interrupts the energization to the electromagnetic coil when a temperature thereof exceeds a predetermined temperature, the method comprising:
a step of winding the electromagnetic coil around the bobbin;
a step of holding a drawn wire part of the electromagnetic coil drawn from an outer edge of a flange portion of the bobbin onto the flange portion halfway through a process of winding the electromagnetic coil around the bobbin, by fitting the drawn wire part into a wire locking portion formed in each of a pair of base portions provided on the flange portion apart from each other in a circumferential direction while pressing the drawn wire part; and
a step of electrically connecting the thermal fuse between one end of the drawn wire part in one of the base portions and one end of the drawn wire part in the other one of the base portions.

9. The method for producing an electromagnetic clutch according to claim 8,
wherein the wire locking portion includes a groove portion into which the drawn wire part of the electromagnetic coil is fitted, and wherein in the step of holding, the drawn wire part of the electromagnetic coil is held by fitting the drawn wire part into the groove portion, while pressing the drawn wire part against a side wall on a bobbin inner peripheral side that is higher than a side wall on a bobbin outer peripheral side from among side walls defining the groove portion.

10. The method for producing an electromagnetic clutch according to claim 8,
wherein the step of electrically connecting the thermal fuse includes:
fitting each connecting terminal into the pair of base portions and pressing the drawn wire part;
removing the drawn wire part between the pair of base portions; and
fixing lead wires of the thermal fuse to the connecting terminals fitted in the pair of base portions, to electrically connect the thermal fuse to the electromagnetic coil via the connecting terminals.

11. The method for producing an electromagnetic clutch according to claim 8,
wherein the step of electrically connecting the thermal fuse includes:
fixing lead wires of the thermal fuse to the pair of base portions;
fitting each connecting terminal into the pair of base portions and pressing the drawn wire part and the lead wires, to electrically connect the thermal fuse to the electromagnetic coil via the connecting terminals; and
removing the drawn wire part between the pair of base portions.
